(19) United States
(12) Patent Application Publication
(10) Pub. No.: US 2003/0140517 A1
(43) Pub. Date: Jul. 31, 2003

(54) Crockery drying apparatus with a condensing device outside the washing chamber

(76) Inventor: Bertram Schmid, Amtzell (DE)

Correspondence Address: SCULLY SCOTT MURPHY & PRESSER, PC, 400 GARDEN CITY PLAZA, GARDEN CITY, NY, 11530

(21) Appl. No.: 10/276,138

(22) PCT Filed: May 11, 2001
(86) PCT No.: PCT/EP01/05421

(30) Foreign Application Priority Data
May 12, 2000 (DE) 100 23 346.5

(51) Int. Cl. F26B 21/06

(52) U.S. Cl. 34/78; 34/73

(57) ABSTRACT

In an apparatus 4 for drying crockery in a washing chamber 2 of a dishwashing machine hot moist washing chamber air is produced, from which moisture is removed by condensation outside the washing chamber 2. In order to keep the amount of water required for condensation small and to keep it in readiness for the next washing operation a heat exchanger 5 is provided outside the washing chamber 2, the heat exchanger surface 6 of the heat exchanger 5 separating a water guide chamber 7 and an air guide chamber 8. The heat exchanger surface 6 is arranged in such a way that condensate runs down under the effect of the force of gravity into an intermediate storage means 9 to which the water guide chamber 7 is connected and which is communicated with the washing chamber 2 by way of a valve 13.

The invention concerns an apparatus for drying crockery in a washing chamber of a dishwashing machine, wherein hot moist washing chamber air which is produced has moisture extracted therefrom by condensation outside the washing chamber and the condensate is collected and the washing chamber air from which moisture has been extracted is returned to the washing chamber.

Dishwashing machines are known in which the hot moist washing chamber air produced in the operation of drying the crockery is blown out into the surrounding atmosphere by means of an exhaust fan. When such an open drying system is used the ambient atmosphere is loaded with water vapor, which is frequently undesirable.

Closed drying systems are also known, in which the moist washing chamber air has moisture extracted therefrom by condensation. With those closed systems either a great deal of water is consumed or the drying result is not satisfactory because only a small amount of heat energy is removed from the washing chamber air in the available time.

An apparatus of the kind set forth in the opening part of this specification is described in EP 0 486 828 B1. There moist air is passed out of the washing chamber by means of a fan into a container which contains fresh water. The moist washing chamber air is intended to condense at the fresh water, whereafter it is recycled into the washing chamber. That means that it is not possible to achieve an effective separation between condensate and air from which moisture has been removed. On the contrary, evaporation can occur again at the surface of the water in the container, and that vapor is undesirably conveyed into the washing chamber again. As condensation takes place essentially only at the horizontal surface of the water, that surface has to be correspondingly large, which results in a considerable amount of space being required.

DE 35 13 639 A1 describes an apparatus for the condensation of water vapor in the washing container by means of cold water. In that arrangement the cold water cools an internal wall side of the washing chamber.

The object of the invention is to provide an apparatus of the kind set forth in the opening part of this specification in which water which is necessary for the condensation operation remains usable and in which condensate and air from which moisture has been removed are effectively separated.

In accordance with the invention the foregoing object is attained by the features of claim 1.

The washing chamber air which has absorbed moisture and heat from the crockery in the drying procedure flows along the cooled heat exchanger surface in the air ducting or guide chamber, in which case moisture condenses at the heat exchanger surface and drains off into the intermediate storage means under the effect of the force of gravity. The air from which moisture has been removed is fed to the washing chamber again. The water which has flowed past the heat exchanger surface and the condensate are collected in the intermediate storage means and are available there for use in a later washing operation. The condensate and the water from which moisture has been removed are effectively separated in the lower region of the heat exchanger surface so that the air which is fed to the washing chamber again has the moisture substantially removed therefrom.

The apparatus can be designed in a space-saving manner so that it does not require an increase in the usual dimensions of a dishwashing machine or a reduction in the volume of the washing chamber.

Preferably, the washing chamber air flows into the air guide chamber through an outlet opening provided at the top on the washing chamber and flows back into the washing chamber through an inlet opening which is at a lower level. That flow direction corresponds to the natural convection of the system as the washing chamber is hot at the top and the washing chamber air, cooled at the heat exchanger surface, moves downwardly. That provides that the circuit of the washing chamber air also takes place in itself without a circulating fan. Preferably however the arrangement has a circulating fan which conveys the moist washing chamber air through the air guide chamber. That permits a more uniform flow around the crockery in the washing chamber. If however the circulating fan fails the washing chamber air circuit is still maintained by virtue of natural convection.

Preferably the heat exchanger surface is at least partially vertically arranged. Particularly reliable separation between the condensate and the air from which moisture has been extracted can be achieved if a separator wall is arranged near the lower edge of the heat exchanger surface in the air guide chamber, wherein at the one side of the separator wall between the latter and the heat exchanger surface there is a gap through which condensate flows away into the intermediate storage means, and at the other side of the separator wall the washing chamber air from which moisture has been removed flows back into the washing chamber.

The water guide chamber is preferably connected to the intermediate storage means by way of a valve or a throttle.

If the arrangement has a throttle then cooling water flows on the heat exchanger surface, preferably in the form of a film of water, during the drying operation, continuously into the intermediate storage means. If the arrangement has a valve the cooling water which is heated by condensation is discontinuously replaced. The valve can be controlled or regulated in dependence on time or in dependence on the temperature of the water in the water guide chamber and/or the temperature of the washing chamber air or in dependence on the moisture content of the washing chamber air. Control or regulation is such as to provide a drying time which is as short as possible and a drying result which is as good as possible.

As an alternative to the water guide chamber being communicated with the intermediate storage means by way of a valve or a throttle, it is provided that the water guide chamber is fed from below with water from a water feed and has an overflow, by way of which the water which rises upwardly in the water guide chamber and which is heated as it does so can flow away into the intermediate storage means. The consequence of this is that—as soon as the water guide chamber is filled to the top with water—continuously heated cooling water flows away into the intermediate storage means by way of the overflow as long as fresh cooling water is introduced into the water guide chamber.

In a preferred embodiment of the invention provided on the intermediate storage means is a heat exchanger element and/or a heat transfer surface such that heat is transferred from the intermediate storage means to the washing chamber air from which moisture has been removed and/or the washing chamber. This provides that the heat which occurs in the condensation process is used for the drying process by the air in the washing chamber or the air from which moisture has been removed being heated. As a result it can entrain more moisture from the crockery to be dried, than would be possible if the air were at a lower temperature.

In a development of the invention the described apparatus is combined with a per se known water intake device and/or a per se known water softening device of the dishwashing machine to form a structural assembly in such a way that the water guide chamber is fed with water from the water intake device or the water softening device.

Further advantageous configurations of the invention are set forth in the appendant claims and the description hereinafter of embodiments by way of example. In the drawing:

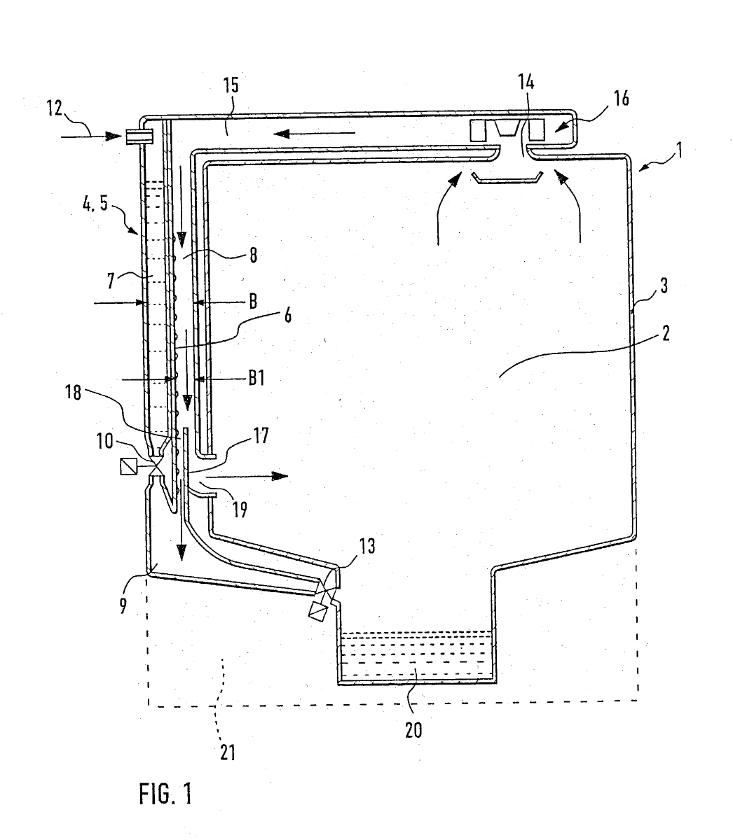

FIG. 1 diagrammatically shows a dishwashing machine with a drying apparatus,

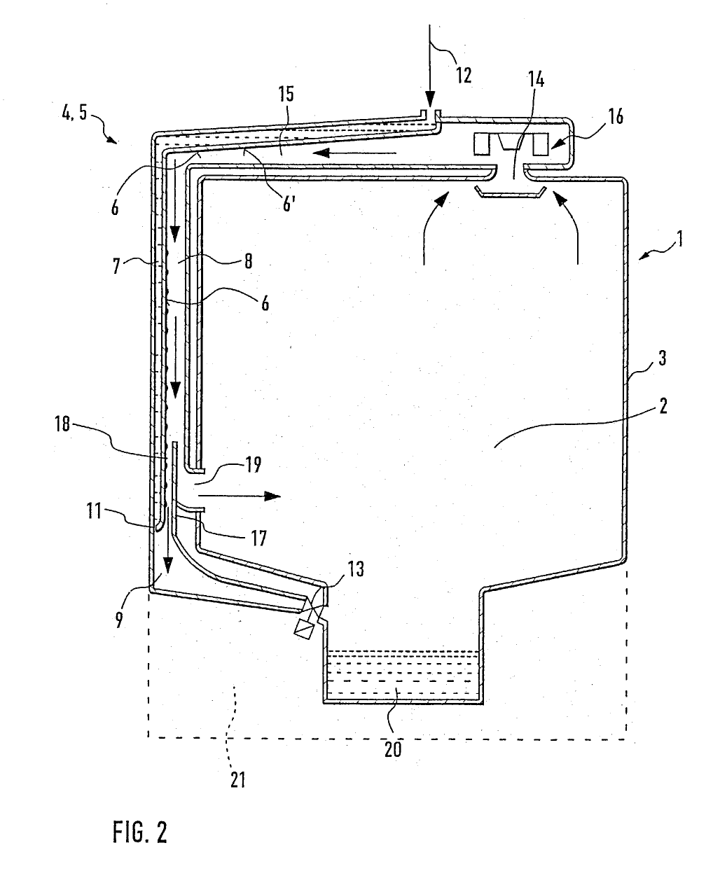

FIG. 2 shows a view corresponding to FIG. 1 of a further embodiment with an alternative heat exchanger,

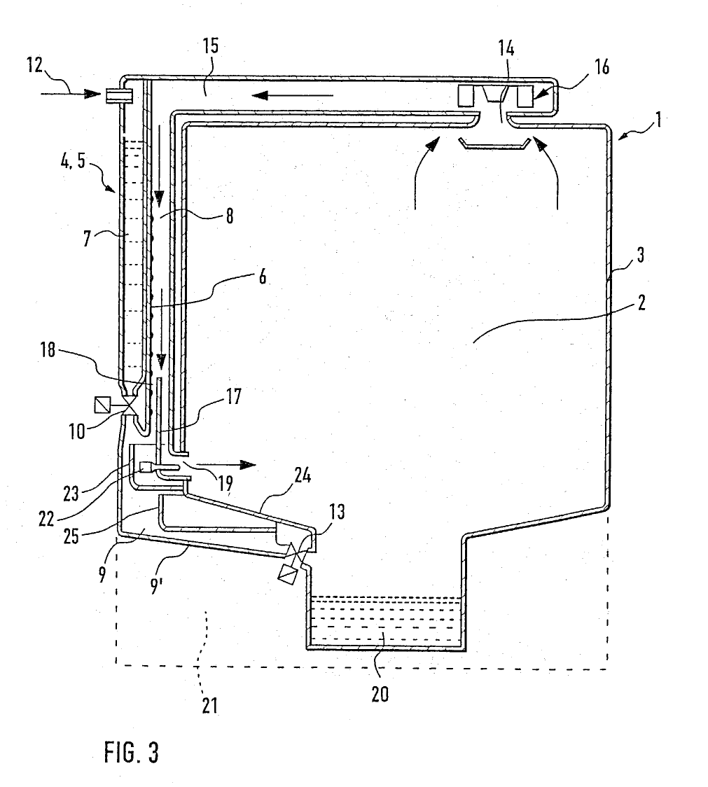

FIG. 3 shows a view corresponding to FIG. 1 of a further embodiment with additional heat transfer, and

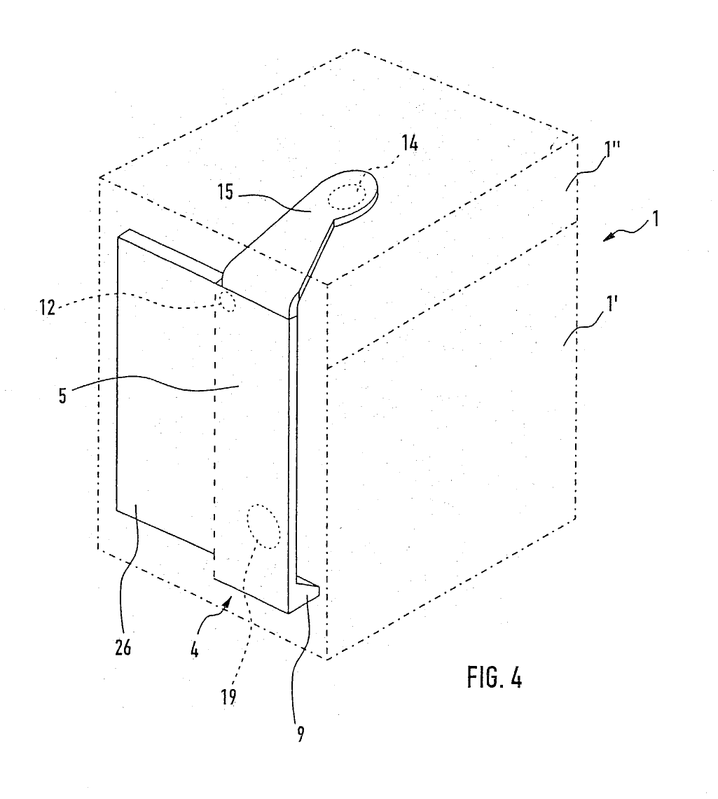

FIG. 4 diagrammatically shows a dishwashing machine, wherein the drying apparatus is integrated with a water intake system or a softening system.

A dishwashing machine 1 has a washing chamber 2 in which are arranged crockery baskets and spray arms (not shown in greater detail). Arranged externally on the washing container 3 forming the washing chamber 2 at the top and laterally or at the rear is a drying apparatus 4.

The drying apparatus 4 has a heat exchanger 5 which at one side of a heat exchanger surface 6 forms a water guide chamber 7 and at the other side of the heat exchanger surface 6 an air ducting or guide chamber 8. Formed below the water guide chamber 7 is an intermediate storage means 9 with which the water guide chamber 7 is communicated by way of a valve 10 in the embodiments shown in FIGS. 1 and 3. In the embodiment shown in FIG. 2 the water guide chamber 7 opens into the intermediate storage means 9 by way of a throttle or capillary 11.

At the top the water guide chamber 7 has a water feed 12 which is connected to the domestic water system directly or by way of a per se known water intake system. The water feed 12 can also be fed by way of a per se known softening system of the dishwashing machine 1. The intermediate storage means 9 opens at the bottom into the washing chamber 2 by way of a valve 13.

Provided at the top on the washing chamber 2 is an outlet opening 14 for hot moist washing chamber air, the outlet opening 14 leading into the air guide chamber 8 by way of a substantially horizontal shaft 15. A circulating fan 16 is disposed in the shaft 15.

A separator wall 17 is arranged in the air guide chamber 8 near the lower edge of the heat exchanger surface 6. A gap 18 is provided between the separator wall 17 and the heat exchanger surface 6, for condensate to flow therethrough. At the other side of the separator wall 17 the air guide chamber 8 opens at the bottom into the washing chamber 2 by way of an inlet opening 19. Depending on the structural space available in the dishwashing machine 1 the width B of the heat exchanger 5 is between about 10 mm and 30 mm. The width B1 of the air guide chamber 8 is between about 5 mm and 15 mm. In comparison the width of the gap 18 is substantially less. The width of the gap 18 is such that condensate drips running down on the heat exchanger surface 6 or a film of condensate running down on the heat exchanger surface 6 passes into the intermediate storage means 9 and as far as possible is not carried back by the air from which moisture has been removed, through the inlet opening 19, into the washing chamber 2.

The extent of the heat exchanger 5, which is perpendicular to the plane of the drawing, is substantially larger than the width. it can be for example about 30 cm.

The volume of the intermediate storage means 9 is substantially larger than the volume of the water guide chamber 7. The volume of the intermediate storage means 9 is for example 1.5 l whereas the volume of the water guide chamber 7 is for example about 0.5 l.

Elements such as knobs or bars can be provided on the heat exchanger surface 6 in the air guide chamber 8, which promote the deposit of condensate.

The mode of operation of the described apparatus is approximately as follows:

In the program step ‘drying’ of the dishwashing machine 1 cold water is let into the water guide chamber 7 when the valve 10 is closed. The circulating fan 16 runs and circulates hot moist washing chamber air out of the washing chamber 2 through the shaft 15, through the air guide chamber 8 and through the inlet opening 19 back into the washing chamber. Condensate is deposited on the heat exchanger surface 6 and runs under the effect of the force of gravity through the gap 18 into the intermediate storage means 9, the valve 13 of which is closed. Therefore air from which moisture has been removed passes into the washing chamber 2 through the inlet opening 19 and promotes further drying of the crockery. In the course of condensation the temperature difference at the heat exchanger surface 16 inevitably falls. If it is no longer sufficient for further effective condensation then the valve 10 is opened and the heated water from the water guide chamber 17 is discharged into the intermediate storage means 9. The valve 10 is thereafter closed again and fresh water is introduced into the water guide chamber 7, whereupon condensation continues again. The valve 10 can be time-controlled in a simple manner. It is however also possible to provide for temperature-dependent control and regulation, in which case the temperature of the water in the water guide chamber 7 and/or the temperature of the washing chamber air, preferably the washing chamber air from which moisture has been removed, is detected in the region of the inlet opening 19. It is also possible to provide for control or regulation of the valve 10 in dependence on the moisture content of the washing chamber air.

It has been found that, in the case of the described apparatus, only about 2 l of water is necessary for condensation, to give a good drying result, with a short drying time. The water required for condensation and the water recovered by condensation is not lost. It is held in readiness in the intermediate storage means 9 for a later washing operation. In the further washing operation the valve 13 is then opened, whereby the water flows from the intermediate storage means 9 downwardly into the washing chamber 2, above a sump zone 20.

Units such as a circulating pump or a heating means of the dishwashing machine 1 can be disposed in a chamber 21 below the intermediate storage means 9.

In the embodiment shown in FIG. 2 the water guide chamber 7 is connected to the intermediate storage means 9 by way of the throttle or capillary 11. Here, the drying step involves a flow of cold water along the heat exchanger surface 6, which is continuous in contrast to the embodiment shown in FIG. 1. The water guide chamber 7 is less wide than in the embodiment of FIG. 1. It is preferably only so narrow that a film of water drains off in the water guide chamber 7 at the heat exchanger surface 6. That avoids cooling water circulating by virtue of a temperature difference in the water guide chamber 7, which would adversely affect the effectiveness of condensation. The throttle or capillary 11 is for example of such a dimension that between 50 ml and 100 ml/min pass therethrough.

In the embodiment of FIG. 2 the heat exchanger surface 6 also extends in a substantially horizontal region 6′ with a slight fall in the region of the shaft 15. That arrangement provides that heat exchange and condensation also already occur in the region of the horizontal shaft 15. The condensation effect is supported by that increase in size of the heat exchanger surface 6. In other respects the embodiment of FIG. 2 is the same as that of FIG. 1.

FIG. 3 shows two measures, by means of which the heat of the water heated by condensation and which flows into the intermediate storage means 9 is used for heating the washing chamber air. Heating the washing chamber air from which moisture has been removed is desirable as heated air absorbs more moisture from the crockery than unheated air. These measures can each be used individually or jointly.

Arranged in the region of the intermediate storage means 9 is a heat exchanger element 22 which on the one hand takes heat from the water of the intermediate storage means 9 and transfers it to the washing chamber air from which moisture has been removed, in the region of the inlet opening 19. In the simplest case the heat exchanger element 22 can be a body of a material which is of a good conductor of heat, which projects on the one hand into the intermediate storage means 9 and on the other into the flow of the air from which moisture has been removed. The heat exchanger element 22 can also be formed by a tube coil which projects into the flow of air from which moisture has been removed and through which flows water from the water guide chamber 7 and condensate. As shown in FIG. 3, provided in the intermediate storage means 9 is a casing portion 23 into which the heat exchanger element 22 projects and which is filled by condensate and water from the water guide chamber 7 before the latter overflows into the intermediate storage means 9.

In FIG. 3 the intermediate storage means 9 adjoins the washing chamber 2 with a heat transfer surface 24. The heat transfer surface 24 is heated by the water of the intermediate storage means 9 and gives off heat to the washing chamber air. So that hot water can quickly pass to the heat transfer surface 24 in the course of the condensation process, provided in the intermediate storage means 9 below same is a casing portion 25 from which the water overflows on to the bottom 9′ of the intermediate storage means 9, the bottom 9′ having a fall to the valve 13.

It will be seen from FIG. 4 that the shaft 15, the heat exchanger 5 and the intermediate storage means 9 form a unitary structural assembly which is prefabricated in one or more pieces and which can be easily fitted in the dishwashing machine.

As shown in FIG. 4 the drying apparatus is combined with a per se known water intake system 26 and/or a per se known water softening system or regenerating metering system to form a structural assembly. In that case the water feed 12 of the heat exchanger 5 is fed from the water intake system or the water softening system of the dishwashing machine 1.

As shown in FIG. 4, an arrangement of the drying apparatus 4 is disposed laterally of the door 1′ of the dishwashing machine 1. The usual operating panel 1″ is disposed above the door 1′.

1. An apparatus for drying crockery in a washing chamber of a dishwashing machine, wherein hot moist washing chamber air which is produced has moisture extracted therefrom by condensation outside the washing chamber and the condensate is collected and the washing chamber air from which moisture has been extracted is returned to the washing chamber, characterised in that provided outside the washing chamber (2) is a heat exchanger (5) which at the one side of a heat exchanger surface (6) forms a water guide chamber (7) and at the other side of the heat exchanger surface (6) an air guide chamber (8) for washing chamber air, and that the heat exchanger surface (6) is so arranged that the moist washing chamber air condenses thereat and the condensate drains off under the action of the force of gravity into an intermediate storage means (9) to which the water guide chamber (7) is connected and which is connected to the washing chamber (2).

2. An apparatus as set forth in claim 1 characterised in that the moist washing chamber air flows into the air guide chamber (8) through an outlet opening (14) provided at the top on the washing chamber (2) and flows back into the washing chamber (2) through an inlet opening (19) which is positioned lower.

3. An apparatus as set forth in claim 1 or claim 2 characterised in that there is provided a circulating fan (16) which conveys the moist washing chamber air through the air guide chamber (8).

4. An apparatus as set forth in one of the preceding claims characterised in that the heat exchanger surface (6) extends at least partially vertically.

5. An apparatus as set forth in one of the preceding claims characterised in that arranged in the air guide chamber (8) are elements such as knobs or bars in such a way that they promote condensation at the heat exchanger surface (6).

6. An apparatus as set forth in one of the preceding claims characterised in that a separator wall (17) is arranged near the lower edge of the heat exchanger surface (6) in the air guide chamber (8), wherein at the one side of the separator wall (17) between same and the heat exchanger surface (6) is a gap through which condensate flows away into the intermediate storage means (6), and the washing chamber air from which moisture has been removed flows back into the washing chamber (2) at the other side of the separator wall (17).

7. An apparatus as set forth in one of the preceding claims characterised in that the water guide chamber (8) can be connected at the top to the domestic water system directly or indirectly by way of a water intake system (26) and/or softening system of the dishwashing machine (1).

8. An apparatus as set forth in one of the preceding claims characterised in that the water guide chamber (7) is communicated with the intermediate storage means (9) by way of a valve (10) or a throttle (11) or a capillary.

9. An apparatus as set forth in claim 8 characterised in that the valve (10) arranged between the water guide chamber (7) and the intermediate storage means (9) is controllable in dependence on time.

10. An apparatus as set forth in claim 8 characterised in that the valve (10) arranged between the water guide chamber (7) and the intermediate storage means (9) is controllable or regulatable in dependence on the temperature of the water in the water guide chamber (7) and/or the temperature of the washing chamber air.

11. An apparatus as set forth in claim 8 characterised in that the valve (10) arranged between the water guide chamber (7) and the intermediate storage means (9) is controllable or regulatable in dependence on the moisture content of the washing chamber air.

12. An apparatus as set forth in one of the preceding claims characterised in that the intermediate storage means (9) is connected to the washing chamber (2) by way of a valve (13).

13. An apparatus as set forth in one of the preceding claims characterised in that the volume of the intermediate storage means (9) is larger than the volume of the water guide chamber (7).

14. An apparatus as set forth in one of the preceding claims characterised in that the volume of the intermediate storage means (9), possibly plus the volume of the water guide chamber (7), is approximately just so great that it accommodates the amount of water required in the drying operation and the condensate produced in the drying operation.

15. An apparatus as set forth in one of the preceding claims characterised in that the water guide chamber (7) is of such a configuration that a water film runs down on the heat exchanger surface (6).

16. An apparatus as set forth in one of the preceding claims characterised in that a heat exchanger element (22) and/or a heat transfer surface (24) is provided on the intermediate storage means (9) in such a way that heat is transferred from the intermediate storage means (9) to the washing chamber air from which moisture has been removed and/or the washing chamber (2).

17. An apparatus as set forth in one of the preceding claims characterised in that the apparatus (4) forms a structural assembly which can be mounted externally to a washing container (3), forming the washing chamber (2), of the dishwashing machine (1).

18. An apparatus as set forth in one of the preceding claims characterised in that the apparatus (4) is combined with a per se known water intake system of the dishwashing machine (1) and/or a per se known water softening system of the dishwashing machine (1) to form a structural assembly.

19. An apparatus as set forth in one of preceding claims 1 through 6 or 12 through 18 characterised in that the water guide chamber (7) can be connected at the bottom to the domestic water system directly or indirectly by way of a water intake system (26) and/or a softening system of the dishwashing machine (1) and at the top has an overflow by way of which the water which has risen upwardly in the water guide chamber (7) flows away into the intermediate storage means (9).
